(19) United States
(12) Patent Application Publication
(10) Pub. No.: US 2015/0034622 A1
(43) Pub. Date: Feb. 5, 2015

(54) STEERING WHEEL

(71) Applicant: NIHON PLAST CO., LTD., Fujinomiya-shi (JP)

(72) Inventor: Ken SASAKI, Fujinomiya-shi (JP)

(21) Appl. No.: 14/446,059

(22) Filed: Jul. 29, 2014

(30) Foreign Application Priority Data
Jul. 30, 2013 (JP) 2013-157973

(51) Int. Cl. B62D 1/06; H05B 3/16

(52) U.S. Cl. CPC B62D 1/065; H05B 3/16
USPC 219/204

(57) ABSTRACT

The present invention is directed to a steering wheel. Turning portions are alternately formed in a longitudinal direction by way of heater wires of heating portions that are fixed to a skin body main body formed in a belt shape. Of the turning potions, on an outer circumferential side of an arc of a rim portion main body, central turning portions in a plurality of arrays are formed so as to be displaced from each other in a longitudinal direction of the rim portion main body. Among the turning portions, on an inner circumferential side of the arc of the rim portion main body, lateral turning portions are formed in such a manner that a dimension in the longitudinal direction of the rim portion main body is smaller in length than that of a respective one of turning pattern portions of the central turning portions.

### CROSS REFERENCE TO RELATED APPLICATIONS

This application claims priority of Japanese Patent Application No. 2013-157973 filed on Jul. 30, 2013. The contents of this application are incorporated herein by reference in their entirety.

### BACKGROUND OF THE INVENTION

1. Field of the Invention

The present invention relates to a wheel provided with a heater wire which is heated by electric power conduction.

2. Description of the Related Art

Conventionally, when a motor vehicle which is a vehicle parked in a cold area such as an outdoor in winter is started up and driven, for example, there has been a demand for reducing a sense of discomfort exerted by the fact that a wheel, that is, a steering wheel is cool.

In order to respond to such a demand, it has been known that there is employed a construction in which a heater wire (an electric heating wire) is incorporated in a rim portion which is a gripping portion formed in a shape of a circular ring, of a steering wheel, and then, the steering wheel are warmed even when a variety of engines are not sufficiently warmed immediately after engine startup, thereby improving amenity.

As such a construction, it has been known that there is employed a construction in which a heater wire is disposed on a back face of a skin body serving as a covering portion, for example, and then this covering portion is wound at the periphery of a supporting member which is a gripping portion main body of a rim portion of the steering wheel.

In order to warm the entirety of the rim portion, the heater wire is alternately turned up in a direction crossing a circumferential direction which is a longitudinal direction of the rim portion (for example, reference should be made to Japanese Unexamined Patent Application Publication No. 61-81272), or alternatively, in a circumferential direction of the rim portion (for example, reference should be made to Japanese Unexamined Patent Application Publication No. 2007-290685).

In the steering wheel as described above, in order to ensure an improvement of a warming performance, it is considered to increase a thickness of a heater wire. In this case, as in the construction of Japanese Unexamined Patent Application Publication No. 61-81272 mentioned above, if this heater wire is alternately turned up in the direction crossing the circumferential direction of the rim portion, there is a need to take an appropriate measure such as increasing the thickness of the skin body, for example, so as not to degrade a design property and a touch sense by the shape of the electric heating wire being exposed to a surface side of the skin body when the skin body is brought into strong contact with the supporting member, and it is not easy to ensure the improvement of the warming performance.

In addition, as in the construction of Japanese Unexamined Patent Application Publication No. 2007-290685 mentioned above, even in the case where the heater wires are alternately turned up in the circumferential direction of the rim portion, a turning pattern of the heater wire is elongated, and thus, there is a need to take an appropriate measure such as increasing the thickness of the skin body, for example, so as not to expose the heater wire to the surface side of the skin body by the heater wire curving and warping at a position on the inner circumferential side of the rim portion, in particular, and it is not easy to ensure the improvement of the warming performance.

### SUMMARY OF THE INVENTION

The present invention has been made in view of the circumstance as described above, and it is an object of the present invention to provide a wheel which is capable of improving a warming performance without degrading a design property and a touch sense.

A wheel according to a first aspect of the present invention is directed to a wheel comprising an operational gripping portion,

wherein the gripping portion comprises:
a gripping portion main body which is provided in a shape having a longitudinal direction along at least a part of an arc; and
a covering portion including: a covering portion main body and a heating portion;
the covering portion main body which is provided in a belt shape having a longitudinal direction along the longitudinal direction of the gripping portion main body, which is wound at the periphery of the gripping portion main body, and in which lateral side parts in the longitudinal direction are jointed at a position on an inner edge side of the gripping portion main body to thereby cover the gripping portion main body; and
the heating portion having a heater wire which is disposed on the gripping portion main body's side of the covering portion main body, and which is heated by electric power conduction, the heating portion being configured to warm the gripping portion by heating of the heater wire,

wherein the heating portion has a plurality of turning portions which are formed by the heater wire, and which are alternately turned up in the longitudinal direction of the gripping portion main body, in a direction crossing the longitudinal direction of the covering portion main body and

wherein the turning portion comprises:
a plurality of central turning portions which are positioned on an outer circumferential side of the arc of the gripping portion main body, which are provided in the direction crossing the longitudinal direction of the gripping portion main body, and which are disposed so as to be displaced from each other in the longitudinal direction of the gripping portion main body; and
a lateral turning portion which is positioned on an inner circumferential side of the arc of the gripping portion main body, and in which a dimension in the longitudinal direction of the gripping portion main body is smaller than that of a respective one of the central turning portions.

The wheel according to a second aspect of the present invention is provided in such a manner that three or more heater wires are disposed in the direction crossing the longitudinal direction of the covering portion main body, the central turning portion is disposed in the heater wire that is positioned at a center side in the direction crossing the longitudinal direction of the covering portion main body, and the lateral turning portions are disposed in the heater wire that is positioned on the lateral sides in the longitudinal direction of the covering portion main body.

The wheel according to a third aspect of the present invention is provided in such a manner that the covering portion main body has a plurality of covering piece portions which are jointed with each other in a longitudinal direction, the turning portions are respectively disposed in the covering piece portions, the heating portion has a coupling portion which is formed by the heater wire at a position at which the covering piece portions are jointed with each other, the coupling portion being configured to extend along the jointed position and couple the turning portions of the covering piece portions to each other.

In so far as the wheel according to the first aspect of the present invention is concerned, among the turning portions that are formed by the heater wire of the heating portion that is fixed to the covering portion main body formed in a belt shape, a plurality of central turning portions are formed on the outer circumferential side of the arc of the gripping portion main body in a direction crossing a longitudinal direction so as to be displaced from each other in the longitudinal direction of the gripping portion main body.

In this manner, on the outer circumferential side of an arc in which a tension force in the longitudinal direction of the gripping portion main body is the largest at the covering portion main body, it becomes difficult for a stress to concentrate on a gap between the central turning portions that are adjacent to each other in the longitudinal direction of the gripping main body, and at this position, it becomes difficult for the covering portion main body to protrude.

In addition, a lateral turning portion in which a dimension in the longitudinal direction of the gripping portion main body is smaller than that of a respective one of the central turning portions is formed on the inner circumferential side of the arc of the gripping portion main body, whereby, even if a heater wire is increased in thickness in order to improve the warming performance, it is possible to restrain an exposition exerted by a deformation of the heater wire in a state in which lateral side parts of the covering portion main body are jointed with each other at a respective position on the outer circumferential side and the inner circumferential side of the arc of the gripping portion main body. Therefore, the warming performance can be improved without degrading the design property and the touch sense.

In so far as the wheel according to the second aspect of the present invention is concerned, among the three or more heater wires that are disposed in the direction crossing the longitudinal direction of the covering portion main body, the central turning portions are disposed as those which are positioned at the center side in the direction crossing the longitudinal direction of the covering portion main body, and the lateral turning portions are disposed as those which are positioned on the lateral sides in the longitudinal direction.

In this manner, the covering portion main body is wound at the periphery of the gripping portion main body so that the lateral positions thereof are set on the inner circumferential side of the arc, whereby the central turning portions can be easily disposed on the outer circumferential side of the arc of the gripping portion main body, and the lateral turning portions can be easily disposed on the inner circumferential side of the arc of the gripping portion main body.

In so far as the wheel according to the second third of the present invention is concerned, along the position at which the covering piece portions are jointed with each other, the coupling portion configured to couple the turning portions of the covering piece portions to each other is folded by the heater wire of the heating portion.

In this manner, it is possible to restrain the heater wire from being stretched at the position at which the covering piece portions are jointed to each other when the covering portion main body is wound at the periphery of the gripping portion main body, and it is also possible to protect the heater wire more reliably while ensuring the length of the heater wire.

### BRIEF DESCRIPTION OF THE DRAWINGS

FIG. 1 is an enlarged plan view showing a part of a covering portion according to an embodiment of a wheel of the present invention;

FIG. 2 is a plan view showing the same covering portion;

FIG. 3 is a perspective sectional view showing a part of the same wheel;

FIG. 4 is a front view showing the same wheel;

FIG. 5 is a perspective view schematically showing a part of the wheel; and

FIG. 6A and FIG. 6B are views, each of which shows an example of the related art, wherein FIG. 6A is a plan view showing a part of a covering portion of the related art, and FIG. 6B is a perspective view schematically showing a part of a wheel of the related art.

### DESCRIPTION OF THE PREFERRED EMBODIMENTS

Hereinafter, an embodiment of a wheel of the present invention will be described with reference to the accompanying drawings.

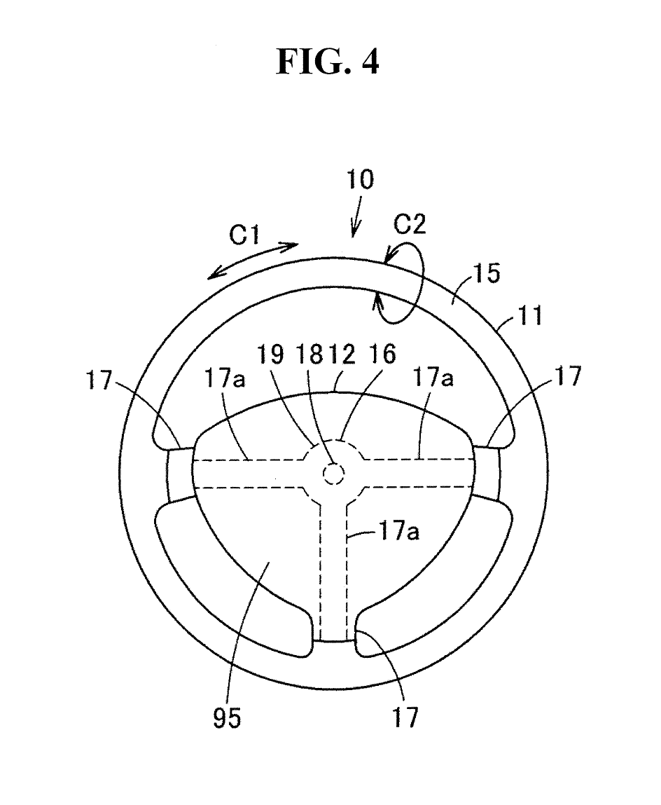

In FIG. 4, reference numeral 10 designates a steering wheel which is a wheel of a motor vehicle serving as a vehicle, for example. This steering wheel 10 is provided with: a steering wheel main body 11 which is a wheel main body; an airbag device (an airbag module) 12 which is a center pad serving as a pad body to be mounted on an occupant side of the steering wheel main body 11; and a switch module, although not shown.

It is to be noted that, although the steering wheel 10 is mounted to a steering shaft which is equipped in a vehicle in a normally inclined state, a description will be given hereinafter, assuming that an occupant side of the airbag device 12, that is, a front side is referred to as an upper side, a steering shaft side, that is, a rear side is referred to as a lower side, a front side of the vehicle, that is, a front glass side of a front upper side is referred to as a front side, and a rear side of the vehicle, that is, a rear lower side is referred to as a rear side or a front side.

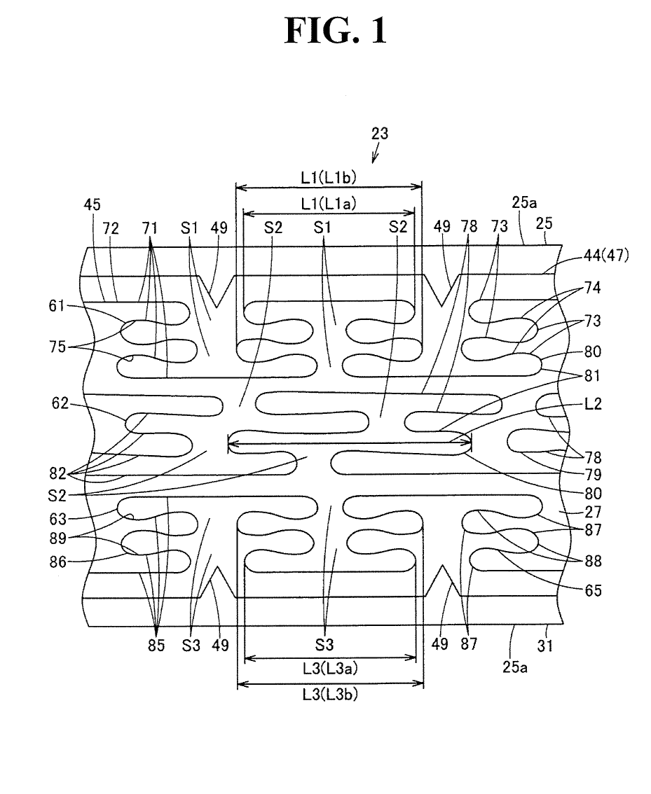

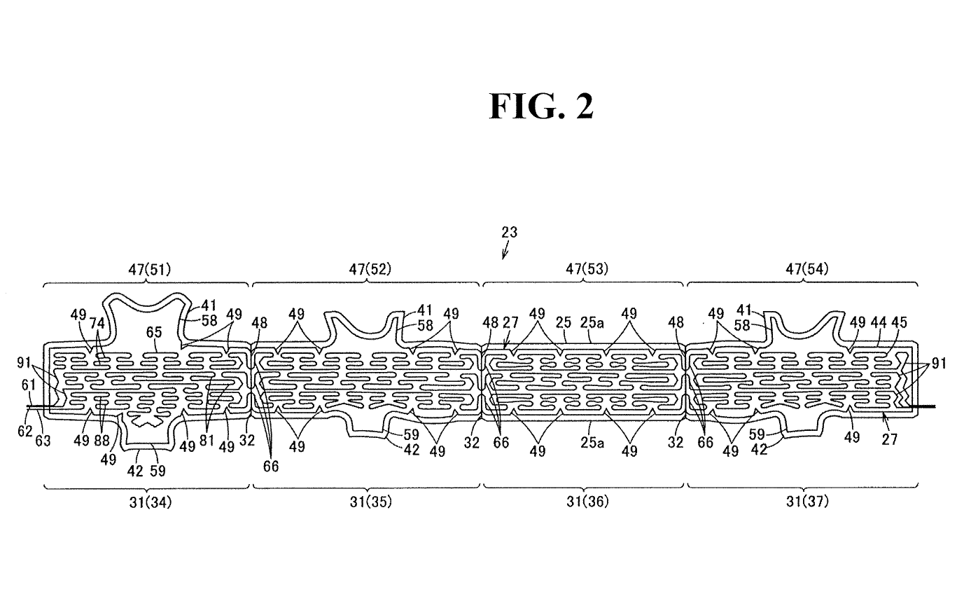

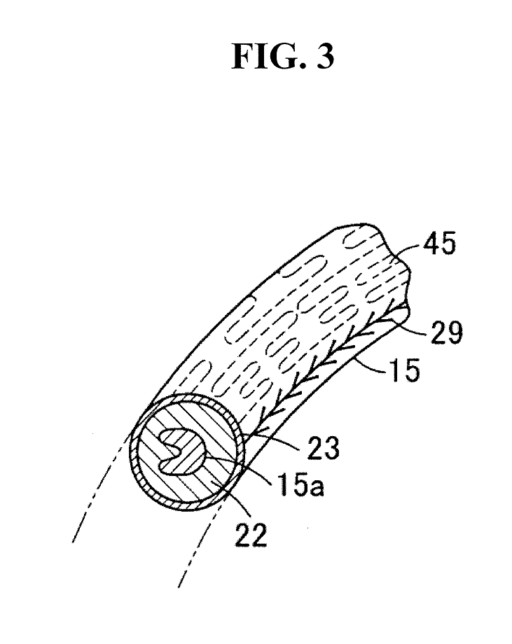

The steering wheel main body 11, as shown in FIG. 1 to FIG. 4, is composed of: a rim portion (a ring portion) 15 serving as a gripping portion which is formed in a shape of a circular ring in the embodiment, at least a part of which is formed along a circumstance; a boss portion 16 which is positioned inside of the rim portion 15; and a plurality of, in the embodiment, three spoke portions 17 configured to couple the rim portion 15 and the boss portion 16 to each other.

In addition, at a lower part referred to as a vehicle body side of the boss portion 16, a substantially cylindrically shaped boss 18, which is provided with a separation structure configured to gear with a steering shaft, is provided, and to this boss 18, a boss plate 19 constituting a core body which is also referred to as a hub core is integrally secured by molding a magnesium alloy or the like, for example.

Further, to the boss portion 16, a lower cover, although not shown, which is made of a resin, and which is also referred to as a back cover or a body cover, is mounted, and a lower part of the boss portion 16 is covered therewith. Moreover, from the boss plate 19, a cored bar 17a which is a spoke cored bar of the spoke portion 17 is integrally extensively provided, or alternatively, is secured by way of welding or the like. Further, to the cored bar 17a of the spoke portion 17, a cored bar 15a of the rim portion 15 is secured by way of welding or the like.

The rim portion 15 is also referred to as a gripping portion or the like, and is provided with: the cored bar 15a which is a rim cored bar; a rim portion main body 22 serving as a gripping portion main body configured to cover an entire circumference of the cored bar 15a; and a skin body 23 serving as a covering portion configured to cover a surface side or the like of at least a part of the rim portion main body 22.

The rim portion 15 (the rim portion main body 22) is formed in a substantially circular shape in a cross section crossing (orthogonal to) a circumferential direction (as indicated by the arrow C1). Therefore, the rim portion 15 (the rim portion main body 22) is formed in a doughnut shape having the circumferential direction as indicated by the arrow C1 and a direction (as indicated by the arrow C2) crossing (orthogonal to) the circumferential direction.

Hereinafter, with respect to the rim portion 15 (the rim portion main body 22), the direction as indicated by the arrow C1 is referred to as a circumferential direction, and the direction as indicated by the arrow C2 is referred to as a sectional circumferential direction.

The rim portion main body 22 is also referred to as a wheel core (a steering core) or the like, and in the embodiment, this main body is made of a material obtained by finely foaming a soft foamed polyurethane resin which is an elastic body, for example.

The rim portion main body 22 is molded by inserting the cored bar 15a and the cored bar 17a into a predetermined die, for example. It is to be noted that the rim portion main body 22 may be formed so as to be multi-layered.

The skin body 23 is provided with: a skin body main body 25 serving as a covering portion main body which is formed in a belt shape (a sheet shape); and a heating portion 27 which is integrally fixed to one main face of the skin body main body 23.

The skin body 23 covers the rim portion main body 22 while the heating portion 27 is referred to as a side of the rim portion main body 22 (a back side), the skin body main body 25 is wound at the periphery of a surface of the rim portion main body 22, and lateral side parts 25a, 25a of the skin body main body 25 are sawn and jointed with each other by way of a sewing yarn 29 or the like, whereby the skin body is fixed to the rim portion main body 22 while enveloping at least a part of the rim portion main body 22.

The skin body main body 25 is formed of a leather (a synthetic leather), or alternatively, a synthetic resin (a urethane rubber) or the like, for example; has a longitudinal direction along a circumferential direction of the rim portion main body 22; and has a widthwise direction (a lateral direction) which is a transverse direction along a sectional circumferential direction of the rim portion main body 22.

The skin main body 25 is constructed in a longitudinal manner while skin body piece portions 32 serving as a plurality of covering piece portions are coupled to each other in a longitudinal direction by way of a jointing portion 32.

It is to be noted that the skin portion main body 25 (the skin body 23) not only denotes only leather, but also denotes an arbitrary member (including a leather, a synthetic leather or the like) formed in a thin film and configured to cover the rim portion main body 22.

In so far as the skin body piece portions 31 are concerned, for example, four first to fourth skin body piece portions 34, 35, 36, 37 are set. A respective one of the first to fourth skin body piece portions 34, 35, 36, 37 is formed in a substantially rectangle shape (in a rectangular slice shape) having a longitudinal direction in the longitudinal direction of the skin body piece portion 31, that is, in the circumferential direction of the rim portion main body 22.

In other words, in so far as the first to fourth skin body piece portions 34, 35, 36, 37 are concerned, a length in a direction along the circumferential direction of the rim portion main body 22 is set so as to be larger than a length in a direction crossing the circumferential direction of the rim portion main body 22.

The first to fourth skin body piece portions 34, 35, 36, 37 are jointed with each other in a longitudinal direction by way of the respective the jointing portions 2.

The first skin body piece portion 34 is positioned at one end in a longitudinal direction of the skin body main body 25, and constitutes a portion corresponding to a spoke portion 17 which is positioned at a lower part, for example, of the skin body 23 (the skin body main body 25).

The second skin body piece portion 35 is positioned between the first and third skin body piece portions 34 and 36, and constitutes a portion corresponding to a spoke portion 17 which is positioned at one side part, for example, of the skin body 23 (the skin body main body 25).

The third skin body piece portion 36 is positioned between the second and fourth skin body piece portions 35 and 37, and constitutes a portion corresponding to an upper part between spoke portions 17, 17 which are positioned at lateral side parts, for example, of the skin body 23 (the skin body main body 25).

The fourth skin body piece portion 37 is positioned at the other end in the longitudinal direction of the skin body main body 25, and constitutes a portion corresponding to a spoke portion 17 which is positioned at the other side part, for example, of the skin body 23 (the skin body main body 25).

In so far as the first, second and fourth skin body piece portions 34, 35, 37 are concerned, at lateral side parts in the longitudinal direction thereof, protrusion piece portions 41, 42 configured to cover a surface of a spoke portion 17 are respectively protrusively provided.

Each of the protrusion piece portions 41 is a portion configured to cover a front side of the spoke portion 17, and is formed in a substantially recessed shape which is hollowed at a center part of a tip end side.

Each of the protrusion piece portions 42 is a portion configured to cover a rear side of the spoke portion 17, and is formed in a substantially rectangular shape. In addition, these protrusion piece portions 41, 42 are jointed with each other at side parts of the spoke portion 17.

In addition, the heating portion 27 is provided with: a supporting member 44 which is bonded with the skin body main body 25; a heater wire 45 which is disposed on one main face of the supporting member 44, and which is heated by electric power conduction; and a control device (a thermo controller), although not shown, which is electrically connected to the heater wire 45, and this heating portion constitutes a planar heater.

The supporting member 44 is formed in a sheet shape by a nonwoven cloth, a leather (a synthetic leather), or alternatively, a urethane rubber or the like, for example, an outer edge part of which is spaced inward with respect to an outer edge part of the skin body main body 25, and a shape of which is somewhat smaller in size than that of the skin body main body 25.

The supporting member 44 is constructed in a longitudinal manner while a plurality of supporting member piece portions 47 are coupled to each other in a longitudinal direction by way of a supporting member jointing portion 48 corresponding to the jointing portion 32.

In so far as the supporting member 44 is concerned, a plurality of V-shaped cut portions (notches) 49 for absorbing wrinkles in a state in which the skin body 23 is wounded at the periphery of the rim portion main body 22 are respectively provided at lateral side parts thereof.

In so far as the supporting member piece portions 47 are concerned, for example, four first to fourth supporting member piece portions 51, 52, 53, 54 corresponding to the first to fourth skin body piece portions 34, 35, 36, 37 are set. The first to fourth supporting member piece portions 51, 52, 53, 54 each are formed in a substantially rectangular shape (a rectangular slice shape) having a longitudinal direction in the longitudinal direction of the supporting member piece portion 47, that is, in the circumferential direction of the rim portion main body 22.

In other words, in so far as the first to fourth supporting member piece portions 51, 52, 53, 54 are concerned, a length in a direction along the circumferential direction of the rim portion main body 22 is set so as to be larger than a length in a direction crossing the circumferential direction of the rim portion main body 22.

The first to fourth supporting member piece portions 51, 52, 53, 54 are jointed with each other in a longitudinal direction by way of the respective supporting member jointing portions 48.

The first supporting member piece portion 51 is positioned at one end in a longitudinal direction of the supporting member 44 (the skin body main body 25), and is overlapped on the first skin body piece portion 34.

The second supporting member piece portion 52 is positioned between the first and third supporting member piece portions 51 and 53, and is overlapped on the second skin body piece portion 35.

The third supporting member piece portion 53 is positioned between the second and fourth supporting member piece portions 52 and 54, and is overlapped on the third skin body piece portion 36.

The fourth supporting member piece portion 54 is positioned at the other end in the longitudinal direction of the supporting member 44 (the skin body main body 25), and is overlapped on the fourth skin body piece portion 37.

In so far as the first, second and fourth supporting member piece portions 51, 52, 54 are concerned, at lateral side parts in the longitudinal direction thereof, tongue piece-shaped protrusion portions 58, 59 configured to cover a surface of the spoke portion 17 and to be overlapped on the protrusion piece portions 41, 42 are respectively protrusively provided.

The heater wires 45 is a single wire in which an insulation film made of a fluorine resin (such as PTFE), for example, is provided on a surface of a core wire to be heated at the time of electric power conduction, for example, and the heater wire mentioned above is fixed to one main face of the supporting member 44 by way of adhesive bonding, welding deposition, or sawing or the like, and is positioned on one main face of the skin body main body 25.

In so far as the heater wire 45 is concerned, for example, three first to third heater wires 61, 62, 63 are set. The heater wires 45 (the first to third heater wires 61, 62, 63) are alternately turned up in the longitudinal direction of the skin body main body 25 that is the circumferential direction of the rim portion main body 22, and a plurality of turn potions 65 which are positioned in a lateral direction of the skin body main body 25 are respectively formed at the first to fourth supporting member piece portions 51, 52, 53, 54 of the supporting member 44 corresponding to the first to fourth skin body piece portions 34, 35, 36, 37 of the skin body piece portion 31 and then these turning portions are coupled to each other by way of coupling portions 66 at the positions of the respective jointing portions 32 (the respective supporting member jointing portions 48).

Therefore, the heater wire 45 is continuous all over both ends of the first to fourth skin body piece portions 34, 35, 36, 37 (the first to fourth supporting member piece portions 51, 52, 53, 54).

The first heater wire 61 is a lateral heater wire (on one side) which is positioned all over the front side from an inner circumferential side (an inner edge side) of the rim portion main body 22 (the rim portion 15), and the heater wire mentioned above constitutes, in proximity to one side part 25a of the skin body main body 25 (the respective skin body piece portions 34, 35, 36, 37 (the respective supporting member piece portions 51, 52, 53, 54)), lateral turning portions 74 (on one side) which have, in a lateral direction, a plurality of first extension portion arrays 72 made of a plurality of extension portions 71 extending along a substantially identical straight line in the longitudinal direction of the skin body main body 25 (the respective skin body piece portions 34, 35, 36, 37 (the respective supporting member piece portions 51, 52, 53, 54)), in which both end parts of a respective one of the first extension portions 71 are respectively coupled to each other by way of a first curved portion 73 curved in an arc shape and then are turned up in a wavy shape in the longitudinal direction of the skin body main body 25 (the respective skin body piece portions 34, 35, 36, 37 (the respective supporting member piece portions 51, 52, 53, 54), and which forms a part of a turning portion 65, is constructed.

Therefore, at the lateral turning portions 74, in a lateral direction of the skin body main body 25 (the respective skin body piece portions 34, 35, 36, 37 (the respective supporting member piece portions 51, 52, 53, 54)), a plurality of (first) turning pattern portions 75 in a plurality of arrays (in at least two arrays, in the embodiment, in five arrays) are set in a longitudinal manner along the longitudinal direction of the skin body main body 25 (the supporting member 44).

As used herein, the turning pattern portion 75 designates a portion which is partitioned between first curved portions 73, 73 configured to connect, in the first heater wire 61: the first extension portions 71 of the first extension portion arrays 72 of a first array and a third array which are odd number arrays from the side of the one side part 25a of the skin body main body 25 (the respective skin body piece portions 34, 35, 36, 37 (the respective supporting member piece portions 51, 52, 53, 54)) (or in a second array and a fourth array which are even number arrays); and with respect to the first extension portions 71, first extension portions 71 of first extension portion arrays 72 of a second array and a fourth array which are even number arrays in a direction opposite to the lateral direction (or a third array and a fifth array which are odd number arrays) to each other.

A longitudinal dimension L1 of a respective one of the turning pattern portions 75 is set so as to be larger in length as it goes to the center side in the lateral direction of the skin body main body 25 (the respective skin body piece portions 34, 35, 36, 37 (the respective supporting member piece portions 51, 52, 53, 54)) and so as to be smaller in length as it goes to the side of the side part 25a (L1a≦L1b in FIG. 1).

In addition, in so far as the respective lateral turning portions 74, 74 (the turning pattern portions 75, 75) that are adjacent to each other in the lateral direction (the vertical direction in FIG. 1) of the skin body main body 25 (the respective skin body piece portions 34, 35, 36, 37 (the respective supporting member piece portions 51, 52, 53, 54)) are concerned, the center positions in the longitudinal direction are not displaced from each other in the longitudinal direction (the transverse direction in FIG. 1) of the skin body main body 25 (the respective skin body piece portions 34, 35, 36, 37 (the respective supporting member piece portions 51, 52, 53, 54)).

Therefore, between the respective lateral turning portions 74, 74 (the turning pattern portions 75, 75) that are adjacent to each other in the longitudinal direction of the skin body main body 25 (the respective skin body piece portions 34, 35, 36, 37 (the respective supporting member piece portions 51, 52, 53, 54)), space portions S1 which are continuous in the lateral direction of the skin body main body 25 (the respective skin body piece portions 34, 35, 36, 37 (the respective supporting member piece portions 51, 52, 53, 54)), and in which the heater wire 45 (the first heater wires 61) is not disposed, are respectively formed, and a cut portion 49 of the supporting member 44 is positioned in a space portion S1 other than a position of the protrusion piece portion 41 (the protrusion portion 58).

The second heater wire 62 is a central heater wire which is positioned on the outer circumferential side (the outer edge side) of the rim portion main body 22 (the rim portion 15), and the heater wire mentioned above has, in a lateral direction, a plurality of second extension portion arrays 79 made of a plurality of second extension portions 78 extending along a substantially identical straight line in the longitudinal direction of the skin body main body 25 (the respective skin body piece portions 34, 35, 36, 37 (the respective supporting member piece portions 51, 52, 53, 54)).

The heater wire mentioned above constitutes, in a lateral direction of the skin body main body 25 (the respective skin body piece portions 34, 35, 36, 37 (the respective supporting member piece portions 51, 52, 53, 54)), center turning portions 81 in which both end parts of a respective one of the second extension portions 78 are respectively coupled to each other by way of a second curved portion 80 curved in an arc shape and then are turned up in a wavy shape in the longitudinal direction of the skin body main body 25 (the respective skin body piece portions 34, 35, 36, 37 (the respective supporting member piece portions 51, 52, 53, 54)), and which forms a part of the turning portion 65.

Therefore, in so far as the central turning portions 81 are concerned, in the lateral direction of the skin body main body 25 (the respective skin body piece portions 34, 35, 36, 37 (the respective supporting member piece portions 51, 52, 53, 54)), a plurality of (second) turning pattern portions 82 in a plurality of arrays (in at least two arrays, in the embodiment, in five arrays) are set in a longitudinal manner along the longitudinal direction of the skin body main body 25 (the supporting member 44).

As used herein, the turning pattern portion 82 denotes a portion which is partitioned between second curved portions 80, 80 configured to connect, in the second heater wire 62: second extension portions 78 in a first array and a third array which are odd number arrays from the side of one side part 25a (the side of first heater wire 61) of the skin body main body 25 (the respective skin body piece portions 34, 35, 36, 37 (the respective supporting member piece portions 51, 52, 53, 54)) (or in a second array and a fourth array which are even number arrays); and with respect to the second extension portions 78, second extension portions 78 of second extension portion arrays 79 in a second array and a fourth array which are even number arrays in a direction opposite to the lateral direction (or in a third array and a fifth array which are odd number arrays) to each other.

A longitudinal dimension L2 of a respective one of the turning pattern portions 82 is set so as to be larger than the longitudinal dimension L1 of a respective one of the turning patterns 75.

In so far as the respective central turning portions 81, 81 (the turning patterns 82, 82) that are adjacent to each other in the lateral direction (the vertical direction in FIG. 1) of the skin body main body 25 (the respective skin body piece portions 34, 35, 36, 37 (the respective supporting member piece portions 51, 52, 53, 54)) is concerned, the center positions are displaced from each other in the longitudinal direction (the transverse direction in FIG. 1) of the skin body main body 25 (the respective skin body piece portions 34, 35, 36, 37 (the respective supporting member piece portions 51, 52, 53, 54)).

Therefore, between the respective central turning portions 81, 81 that are adjacent to each other in the longitudinal direction of the skin body main body 25 (the respective skin body piece portions 34, 35, 36, 37 (the respective supporting member piece portions 51, 52, 53, 54)), space portions S2 in which the heater wire 45 (the second heater wires 62) are not disposed are respectively formed at their appropriate positions.

The space portions S2 in the respective arrays of the central turning portions 81 that are adjacent to each other in the lateral direction of the skin body main body 25 (the respective skin body piece portions 34, 35, 36, 37 (the respective supporting member piece portions 51, 52, 53, 54)) are provided so as not to be displaced from each other in the longitudinal direction of the skin body main body 25 (the respective skin body piece portions 34, 35, 36, 37 (the respective supporting member piece portions 51, 52, 53, 54)) and then be continuous in the lateral direction thereof.

The third heater wire 63 is a lateral heater wire (on the other side) which is positioned all over the rear side from the inner edge side) of the rim portion main body 22 (the rim portion 15), and has, in a lateral direction, a plurality of third extension portion arrays 86 made of a plurality of third extension portions 85 extending along a substantially identical straight line in the longitudinal direction of the skin body main body 25 (the respective skin body piece portions 34, 35, 36, 37).

The heater wire mentioned above constitutes, in proximity to the other side part 25a of the skin body main body 25 (the respective skin body piece portions 34, 35, 36, 37), lateral turning portions 88 (on the other side) in which both end parts of a respective one of the third extension portions 85 are respectively coupled to each other by a third curved portions 87 curved in an arc shape and then are turned up in a wavy shape in the longitudinal direction of the skin body main body 25 (the respective skin body piece portions 34, 35, 36, 37 (the respective supporting member piece portions 51, 52, 53, 54)), and which forms a part of the turning portion 65.

Therefore, in so far as the lateral turning portions 88 are concerned, in the lateral direction of the skin body main body 25 (the respective skin body piece portions 34, 35, 36, 37 (the respective supporting member piece portions 51, 52, 53, 54)), a plurality of (third) turning pattern portions 89 in a plurality of arrays (in at least two arrays, in the embodiment, in five arrays) are set in a longitudinal manner along the longitudinal direction of the skin body main body 25 (the supporting member 44).

As used herein, the turning pattern portion 89 denotes a portion which is partitioned between third curved portions 87, 87 configured to connect, in the third heater wire 63: third extension portions 85 of third extension portion arrays 86 in a first array and a third array which are odd number arrays from the side of the other side part 25a of the skin body main body 25 (the respective skin body piece portions 34, 35, 36, 37 (the respective supporting member piece portions 51, 52, 53, 54)) (or a second array and a fourth array which are even number arrays); and with respect to the first extension portions 71, the first extension portions 71 of the first extension portion arrays 72 in a second array and a fourth array which are even number arrays in a direction opposite to the lateral direction.

A longitudinal dimension L3 of a respective one of the turning pattern portions 89 is set so as to be larger in length as it does to a center side in the lateral direction of the skin body main body 25 (the respective skin body piece portions 34, 35, 36, 37 (the respective supporting member piece portions 51, 52, 53, 54)) and so as to be smaller in length as it goes to the side of the other side part 25a (L3a≦L3b in FIG. 1), and is set so as to be smaller in length than the longitudinal dimension L2 of a respective one of the turning pattern portions 82. In addition, between the turning patterns 89, 89, a cut portion 49 of the supporting member 44 is positioned.

In addition, in so far as the respective lateral turning portions 88, 88 (the turning pattern portions 89, 89) that are adjacent to each other in the lateral direction (the vertical direction in FIG. 1) of the skin body main body 25 (the respective skin body piece portions 34, 35, 36, 37 (the respective supporting member piece portions 51, 52, 53, 54)) are concerned, the center positions in the longitudinal direction are not displaced from each other in the longitudinal direction (the transverse direction in FIG. 1) of the skin body main body 25 (the respective skin body piece portions 34, 35, 36, 37 (the respective supporting member piece portions 51, 52, 53, 54)).

Therefore, between the respective lateral turning portions 88, 88 that are adjacent to each other in the longitudinal direction of the skin body main body 25 (the respective skin body piece portions 34, 35, 36, 37 (the respective supporting member piece portions 51, 52, 53, 54)), space portions S3 which are continuous in the lateral direction 25 (the respective skin body piece portions 34, 35, 36, 37 (the respective supporting member piece portions 51, 52, 53, 54)), and in which the heater wire 45 (the third heater wires 63) is not disposed, are respectively formed at their appropriate positions, and a cut portion 49 of the supporting member 44 is positioned in a space portion S3 other than a position of the protrusion piece portion 42 (the protrusion portion 59).

In so far as the turning portion 65 is concerned, a respective one of the longitudinal dimensions L1, L3 of the turning pattern portions 75, 89 of the lateral turning portions 74, 88 is set so as to be smaller in length than the longitudinal dimension L2 of the turning pattern portion 82 of the central turning portion 81.

Each coupling portion 66 is configured to couple end parts of the first extension portions 71, 71 sandwiching the jointing portion 32 in the first extension portion array 72 that is the most proximal to one side part of the first heater wire 61 to each other; to couple end parts of the second extension portions 78, 78 sandwiching the jointing portion 32 in the second extension portion array 79 that is the most proximal to the other side part of the second heater wire 62 to each other; and to couple end parts of the third extension portions 85, 85 sandwiching the jointing portion 32 in the third extension portion array 86 that is the most proximal to the other end part of the third heater wire 63 to each other.

Each coupling portion 66 extends, along the jointing portion 32, in the lateral direction of the skin body main body 25 (the respective skin body piece portions 34, 35, 36, 37 (the respective supporting member piece portions 51, 52, 53, 54)); crosses the jointing portion 32 at a tip end position; and are continuous in the longitudinal direction of the skin body main body 25 ((the respective skin body piece portions 34, 35, 36, 37 (the respective supporting member piece portions 51, 52, 53, 54)).

Therefore, each coupling portion 66 extends along a sectional circumferential direction of the rim portion main body 22.

Terminal end extension portions 91 which extend in the lateral direction of the skin body main body 25 (the respective skin body piece portions 34, 37) are respectively formed at the end parts of the first to third heater wires 61, 62, 63.

Both ends of the first to third heater wires 61, 62, 63 are led out from both ends in the longitudinal direction of the skin body main body 25 at their appropriate positions of the inner edge side of the rim portion main body 22 (the rim portion 15) and then are electrically connected to the control device, respectively.

The control device is provided with a thermostat or the like, for example, and is electrically connected to both end parts of the heater wire 45 (the first to third heater wires 61, 62, 63) via a power supply line, although not shown. This control device is housed between a lower cover and the cored bar 17a of the spoke portion 17 of the steering wheel main body 11, for example.

The airbag device 12 is provided with: a baggy airbag; a covering body 95 made of a resin and configured to cover the folded airbag; and a gas jetting inflator or the like. This airbag device 12 is configured to rapidly jet a gas from the inflator into the airbag, rapidly inflate the folded and housed airbag, cleave the covering body 95, inflate and expand the airbag toward a front side of an occupant, and protect the occupant in case that a motor vehicle collides with an obstacle or the like.

It is to be noted that this airbag device 12 may integrally incorporate a horn switch mechanism serving as a switching device.

At the time of manufacturing the steering wheel 10, cored bars 15a, 17a integrated with a boss plate 19 or the like are placed in a predetermined die, a resin material is filled at the periphery of this cored bar 15a, the rim portion main body 22 is formed and then is released from the predetermined die, and further, the skin body 23 is covered at the periphery of the rim portion main body 22.

At this time, the heating portion 27 (the heater wire 45) is referred to as the side of the rim portion main body 22; the skin body 23 is wound at the periphery of the rim portion main body 22 so as to position lateral side parts 25a, 25a of the skin body main body 25 on the inner circumferential side (the inner diameter side) of the rim portion main body 22; the lateral side parts 25a, 25a of the skin body main body 25 are sewn on the inner circumferential side (the inner diameter side) of the rim portion main body 22 by way of a sewing yarn 29, for example; and the skin body 23 is fixed to a surface of the rim portion main body 22.

In this state, in so far as the heater wire 45 is concerned, the lateral turning portions 74, 88 are positioned on the inner circumferential side (the inner diameter side) of the rim portion 15 (the rim portion main body 22), and the central turning portion 81 is positioned on the outer circumferential side (the outer diameter side) of the rim portion 15 (the rim portion main body 22).

In so far as the respective turning pattern portions 75, 89 of the lateral turning portions 74, 88 are concerned, a respective one of the longitudinal dimensions L1, L3 is smaller than the longitudinal dimension L2 of a respective one of the turning pattern portions 82 of the central turning portions 81, whereby the turning pattern portion 82 easily follows the outer circumferential side of the rim portion main body 22 and then is positioned along the outer circumferential side of the rim portion main body 22, and the respective turning pattern portions 75, 89 easily follow the inner circumferential side of the rim portion main body 22, a radial diameter of which is smaller than that of the outer circumferential side, and a curvature of which is larger than that of the outer circumferential side, and then, these turning pattern portions are positioned along the inner circumferential side of the rim portion main body 22.

The heater wire 45 led out from both end parts of the skin body 23 is housed in a recessed portion at a position of a lower spoke portion 17, and are electrically connected to the control device.

Further, the airbag device 12 and the lower cover or the like that are additionally assembled are mounted to the boss portion 16, and a variety of wirings or the like are provided to thereby complete the steering wheel 10.

In so far as the steering wheel 10 is concerned, at the time of startup of a motor vehicle, the heater wire 45 (the heating portion 27) is heated by electric power conduction from the control device that is electrically powered from a power supply side, and then, an entire surface of the rim portion 15 is warmed via the skin body main body 25.

In this manner, in the embodiment, in so far as the turning portions 65 that are alternately turned and formed in the longitudinal direction (the circumferential direction of the rim portion main body 22) by way of the heater wire 45 of the heating portion 27 that is fixed to the belt-shaped skin body main body 25 is concerned, on the outer circumferential side of the arc of the rim portion main body 22, the central turning portions 81 in a plurality of arrays in the lateral direction are formed so as to be displaced from each other in the longitudinal direction of the rim portion main body 22.

Thus, at the positions on the outer circumferential side of the rim portion main body 22, the space portions S2, S2 between the central turning portions 81, 81 that are adjacent to each other in the longitudinal direction are not continuous in a belt shape in the sectional circumferential direction of the rim portion main body 22 (the lateral direction of the skin body 23). Therefore, in the skin body 23 that is wound at the periphery of the rim portion main body 22, on the outer circumferential side of the rim portion main body 22 in which a curvature is relatively small and a tension force (a pulling force) in the circumferential direction is the largest, a stress concentrate on the positions of these space portions S2, and it becomes difficult for the skin body main body 25 to locally protrude.

In addition, in so far as the turning portions 65 are concerned, on the inner circumferential side of the arc of the rim portion main body 22, lateral turning portions 74, 88 (the turning pattern portions 75, 89) are formed in such a manner that a dimension in the longitudinal dimension of the rim portion main body 22 is smaller in length than that of a respective one of the central turning portions 81 (the turning pattern portions 82).

Thus, even if the heater wire 45 is increased in thickness in order to improve the warming performance, it is possible to restrain the exposition exerted by the deformation of the heater wire 45 in a state in which the skin body main body 25 is wound at the periphery of the rim portion main body 22 and then at the positions on the inner edge side of the rim portion main body 22, lateral side parts 25a, 25a of the skin body main body 25 are jointed with each other.

Further, in so far as the turning portions 65 are concerned, on the inner circumferential side of the arc of the rim portion main body 22, the lateral turning portions 74, 88 in a plurality of arrays in the lateral direction are formed so as not to be displaced from each other in the longitudinal direction of the rim portion main body 22.

Thus, at the positions on the inner circumferential side of the rim portion main body 22, the space portions S1, S1 between the lateral turning portions 74, 74 that are adjacent to each other in the longitudinal direction and the space portions S3, S3 between the lateral turning portions 88, 88 are respectively continuous in a belt shape in the sectional circumferential direction of the rim portion main body (the lateral direction of the skin body 23).

In this manner, on the inner circumferential side of the rim portion main body 22 in which a curvature is relatively large in the skin body 23 that is wound at the periphery of the rim portion main body 22 and a compression force is the largest, a dimensional difference in the circumferential direction can be absorbed by the positions of the space portions S1, S3 in which these heater wire 45 (the heater wires 61, 63) is not disposed, and it becomes difficult for the skin body main body 25 to locally protrude. Therefore, the warming performance can be improved without degrading the design property and the touch sense.

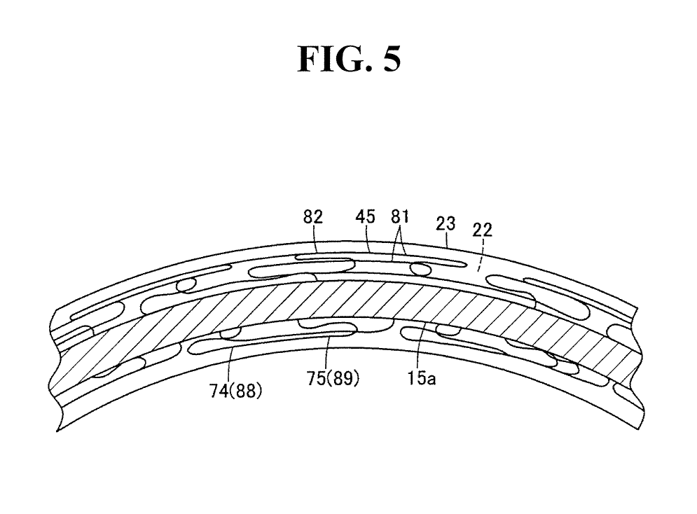

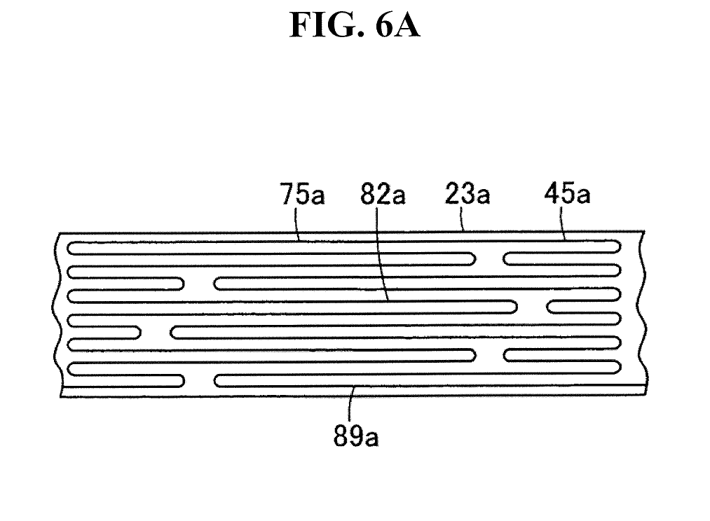

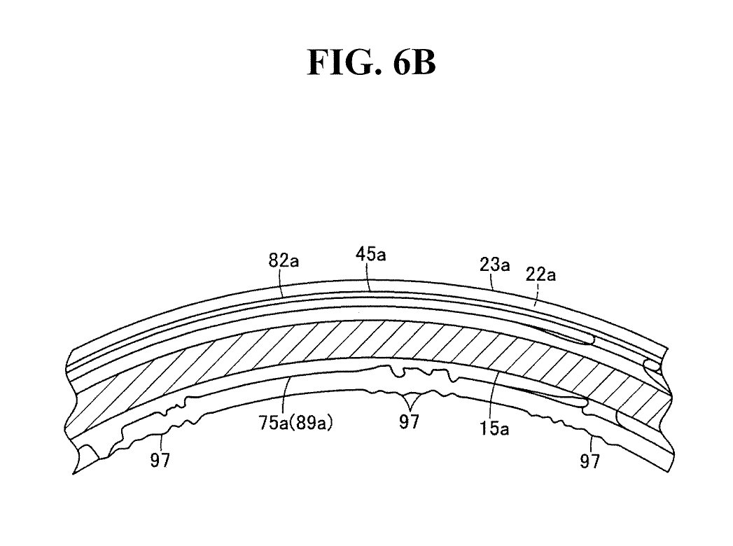

For example, as shown in FIG. 6A, in a case where a length of a respective one of turning pattern portions 75a, 82a, 89a is large all over the skin body main body 25, when the skin body 23a is wound at the periphery of the rim portion main body 22a, in particular, at the position on the inner circumferential side, and a heater 45a cannot follow the rim portion main body 22a, a local folding takes place, and when the heater wire 45a is increased in thickness, a protrusion portion 97 is exposed outside of the skin body 23a (FIG. 6B). On the other hand, in the embodiment, a length of a respective one of the turning pattern portions 75, 89 of the lateral turning portions 74, 78 is set so as to be smaller in length than that of a respective one of the turning patterns 82 of the central turning portions 81 of the turning portions 65. Thus, even if the heater wire 45 reliably follows the rim portion main body 22 without folding and then the heater wire 45 is increased in thickness, it becomes difficult for the heater wire 45 to be exposed to the skin body 23 (FIG. 5).

In so far as the turning pattern portions 75, 89 are concerned, a respective one of the longitudinal dimensions L1, L3 is set so as to be smaller in length as it goes to lateral side parts 25a of the skin body main body 25 that is positioned at the innermost circumference of the rim portion main body 22. Thus, these turning pattern portions 75, 89 reliably follow the shape of the rim portion main body 22, no local folding takes place, and even if the heater wire 45 is increased in thickness, it becomes more difficult for the heater wire 45 to be exposed to the outside of the skin body 23.

In so far as the three or more heater wires 45 that are disposed in the direction crossing the longitudinal direction of the skin body main body 25 are concerned, a central turning portion 81 is disposed in the second heater wire 62 that is positioned on the center side in the lateral direction crossing the longitudinal direction of the skin body main body 25, and lateral turning portions 74, 88 are respectively disposed in the first and third heater wires 61, 63 that are positioned on the lateral sides in the longitudinal direction of the skin body main body 25.

In this manner, the skin body main body 25 is wound at the periphery of the rim portion main body 22 so that the positions on the lateral sides thereof are set on the inner circumferential side of the arc of the rim portion main body 22, whereby the central turning portion 81 can be disposed easily and reliably on the outer circumferential side of the arc of the rim portion main body 22, and the lateral turning portions 74, 88 can be disposed easily and reliably on the inner circumferential side of the arc of the rim portion main body 22.

Along the positions of the respective jointing portions 32 at which the skin body piece portions 31 are jointed with each other, the coupling portions 66 configured to couple the turning portions 65 of the skin body piece portions 31 to each other are formed by the heater wires 45 of the heating portions 27.

In this manner, when the skin body main body 25 is wound at the periphery of the rim portion main body 22, it is possible to restrain the heater wires 45 from being stretched out in the longitudinal direction (the circumferential direction of the rim portion 15) at the positions of the jointing portions 32 at which the skin body piece portions 31 are jointed with each other, and the heater wires 45 can be protected more reliably while the length of a respective one of the heater wires 45 can be ensured.

It is to be noted that, according to the foregoing embodiment, the number of heater wires 45 may be one or two, for example, or alternatively, the number thereof may be in plurality such as four or more.

Further, in so far as the heater wires 45 are concerned, as long as the central turning portions 81 that are adjacent to each other in the lateral direction are displaced from each other in the longitudinal direction and a length of a respective one of the turning pattern portions 75, 89 of the lateral turning portions 74, 88 is smaller than a length of a respective one of the turning pattern portions 82 of the central turning portions 81 of the turning portions 65, it is possible to arbitrarily set other shapes without being limitative to the foregoing embodiment.

The rim portion 15 does not always need to be formed in the shape of the circular ring, or alternatively, this rim portion may be formed in an arc shape or the like, as long as it is possible to form a shape having a longitudinal direction along at least a part of the arc.

The steering wheel 10 is not limited to a construction provided with three spoke portions 17, and can also be applied to a construction or the like provided with four spoke portions 17, for example.

In place of the airbag device 12, for example, there can be employed a pad body configured to house an impact absorbing body, for example.

### INDUSTRIAL APPLICABILITY

The present invention can be preferably employed as a steering wheel of a motor vehicle, for example.

What is claimed is:

1. A steering wheel comprising an operation gripping portion,
wherein the gripping portion comprises:
a gripping portion main body which is provided in a shape having a longitudinal direction along at least a part of an arc; and
a covering portion including: a covering portion main body and a heating portion;
the covering portion main body which is provided in a belt shape having a longitudinal direction along the longitudinal direction of the gripping portion main body, which is wound at the periphery of the gripping portion main body, and in which lateral side parts in the longitudinal direction are jointed at a position on an inner edge side of the gripping portion main body to thereby cover the gripping portion main body; and
the heating portion having a heater wire which is disposed on the gripping portion main body's side of the covering portion main body, and which is heated by electric power conduction, the heating portion being configured to warm the gripping portion by heating of the heater wire,
wherein the heating portion has a plurality of turned portions which are formed by the heater wire, and which are alternately turned up in the longitudinal direction of the gripping portion main body, in a direction crossing the longitudinal direction of the covering portion main body and
wherein the turned portion comprises:
a plurality of central turned portions which are positioned on an outer circumferential side of the arc of the gripping portion main body, which are provided in the direction crossing the longitudinal direction of the gripping portion main body, and which are disposed so as to be displaced from each other in the longitudinal direction of the gripping portion main body; and
a turned portion of the inner circumferential side which is positioned on the arc of the gripping portion main body, and which is smaller than the dimension of the longitudinal direction of the gripping portion main body a central turned portions.

2. The steering wheel according to claim 1, wherein
three or more heater wires are disposed in the direction crossing the longitudinal direction of the covering portion main body,
the central turning portion is disposed in the heater wire that is positioned at a center side in the direction crossing the longitudinal direction of the covering portion main body, and
a turned portion of the inner circumferential side are disposed in the heater wire that is positioned along both sides in the longitudinal direction of the covering portion main body.

3. The steering wheel according to claim 1, wherein
the covering portion main body has a plurality of covering piece portions which are jointed with each other in a longitudinal direction,
the turned portions are respectively disposed in the covering piece portions,
the heating portion has a connecting portion which is formed by the heater wire at a position at which the covering piece portions are jointed with each other,
the connecting portion being configured to extend along the jointed position and connect the turned portions of the covering piece portions to each other.
